(19) United States
(12) Patent Application Publication
(10) Pub. No.: US 2019/0392217 A1
(43) Pub. Date: Dec. 26, 2019

(54) METHOD OF REPRESENTING CONTENT OF AUGMENTED REALITY SIMULATOR

(71) Applicant: Korea Electronics Technology Institute, Seongnam-si (KR)

(72) Inventors: Yang Keun AHN, Seoul (KR); Young Choong Park, Goyang-si (KR)

(21) Appl. No.: 16/446,459

(22) Filed: Jun. 19, 2019

(30) Foreign Application Priority Data
Jun. 21, 2018 (KR) 10-2018-0071572

(51) Int. Cl. G06K 9/00; G06T 19/00; G06T 7/194; G02B 27/00

(52) U.S. Cl. CPC G06K 9/00671; G02B 27/0093; G06T 7/194; G06T 19/006

(57) ABSTRACT

The present application relates to a method of representing content of an augmented reality (AR) simulator, and more specifically, to a service method for representing AR content in a simulator for a moving apparatus (an automobile, a monorail car, a cable car, a drone, etc.) according to a background. The method of representing content of an AR simulator includes recognizing AR code using background image content presented by a background screen controller and synchronizing AR content corresponding to the recognized AR code with the background image content and outputting the synchronized AR content.

### CROSS-REFERENCE TO RELATED APPLICATION

This application claims priority to and the benefit of Korean Patent Application No. 10-2018-0071572, filed on Jun. 21, 2018, the disclosure of which is incorporated herein by reference in its entirety.

### BACKGROUND

### 1. Field

The present disclosure relates to a method of representing content of an augmented reality (AR) simulator, and more specifically, to a service method of representing AR content in a simulator for a moving apparatus (an automobile, a monorail car, a cable car, a drone, etc.) according to a background.

### 2. Discussion of Related Technology

Augmented reality (AR) is defined as a technology that superimposes a three-dimensional (3D) virtual image on a user's view of the real world and provides a single composite image.

In AR simulator systems according to the related art, communication frequently occurs between background image reproducing apparatuses and AR reproducing apparatuses and hence a process of synchronizing reproduction times is required.

However, such time mapping has a problem in that an AR device is not synchronized to a background image play time due to a synchronization transmission time.

Particularly, there is a problem that it is difficult to precisely synchronize a background image in a time-synchronous manner when the background image is played in a variable speed manner.

### SUMMARY

One aspect is a method of representing content of an augmented reality (AR) simulator which may solve the problems of the time-synchronization method in accordance with the related art by suggesting a synchronization method that recognizes AR code when AR content is output according to a change in background.

Another aspect is a method of representing content of an AR simulator including recognizing AR code using background image content presented by a background screen controller and synchronizing AR content corresponding to the recognized AR code with the background image content and outputting the synchronized AR content.

### BRIEF DESCRIPTION OF THE DRAWINGS

The above and other objects, features and advantages of the described technology will become more apparent to those of ordinary skill in the art by describing exemplary embodiments thereof in detail with reference to the accompanying drawings.

FIG. 1 is a flowchart illustrating a method of representing content of an augmented reality (AR) simulator according to one embodiment of the present invention.

FIG. 2 is a block diagram illustrating an AR simulator according to one embodiment of the present invention.

FIG. 3 is a block diagram illustrating an AR simulator according to another embodiment of the present invention.

FIGS. 4A and 4B are diagrams illustrating application examples of an AR simulator according to one embodiment of the present invention.

FIG. 5 is an illustration showing background image content and AR content according to one embodiment of the present invention.

FIG. 6 is a view illustrating an example of a computer system in which a method according to an embodiment of the present invention is performed.

### DETAILED DESCRIPTION

Advantages and features of the described technology and methods of achieving the same will be apparent by referring to embodiments described below in detail with reference to the accompanying drawings.

However, the present invention is not limited to the embodiments described below and various modifications may be made thereto. The embodiments are merely provided to thoroughly disclose the invention and to convey the category of the invention to one of ordinary skill in the art. The present invention is defined by the appended claims.

The terminology used herein is for the purpose of describing particular embodiments only and is not intended to be limiting of the invention. As used herein, the singular forms “a”, “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

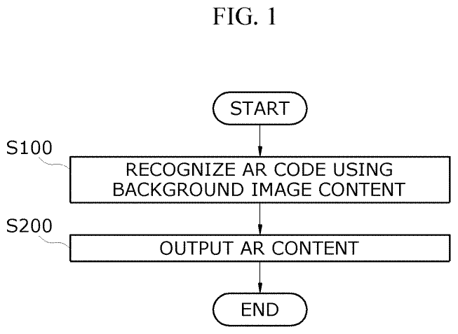

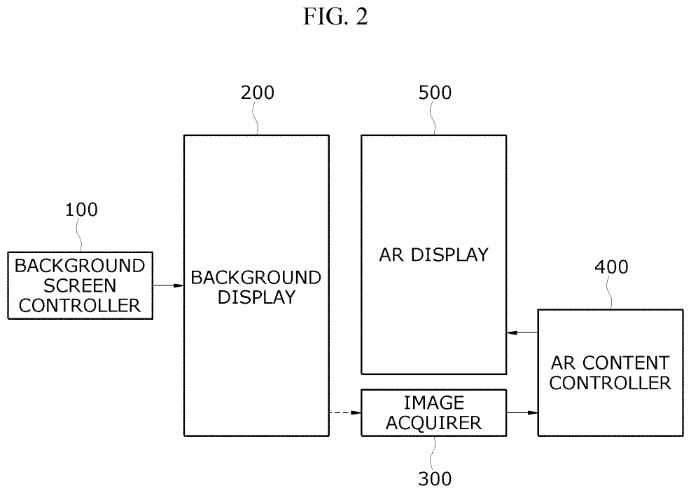

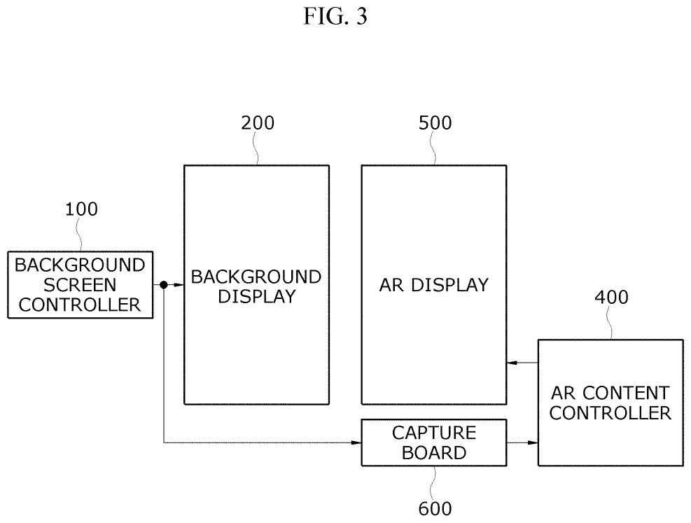

FIG. 1 is a flowchart illustrating a method of representing content of an augmented reality (AR) simulator according to one embodiment of the present invention, FIG. 2 is a block diagram illustrating an AR simulator according to one embodiment of the present invention, and FIG. 3 is a block diagram illustrating an AR simulator according to another embodiment of the present invention.

The method of representing content of an AR simulator according to one embodiment of the present invention includes recognizing an AR code using background image content presented by a background screen controller (S100) and synchronizing AR content corresponding to the recognized AR code with the background image content (S200).

A background screen controller 100 may reproduce a front view seen by a user in, for example, a moving apparatus on a background display 200.

According to one embodiment of the present invention, the AR code is reproduced in a predetermined region of the background display 200 on which the background image content is displayed, and as shown in FIG. 2, an image acquirer 300 recognizes the AR code and transmits recognized information to an AR content controller 400.

The AR code includes a position of an AR content object on the background image, an object ID, a display period, and the like, and any type of code capable of transmitting information, such as barcode, quick response (QR) code, and the like, is applicable.

According to one embodiment of the present invention, the AR code appears in the predetermined region of the background display 200, and it is also possible to overcome spatial restrictions in representation of AR code by applying techniques such as color code, adjustment of transparency, and the like.

In addition, not only does a manager directly add the AR code to the background image, but a processor may also analyze the background image and automatically add related AR code or automatically add a variety of code information, which is stored in a database, at the time of analyzing a background region.

According to one embodiment of the present invention, the AR content controller 400 receives AR information and transmits the AR information so that the AR content is displayed through an AR display 500.

Referring to FIG. 3, according to another embodiment of the present invention, a capture board 600 receives image information transmitted from a background screen controller 100 to a background display 200 and an AR content controller 400 extracts AR content by recognizing AR code from recognized image information.

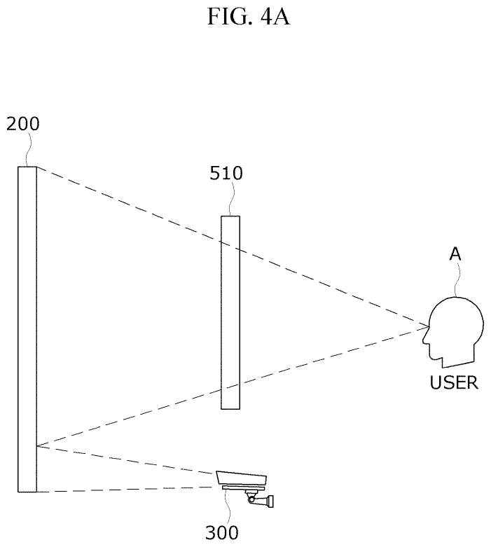

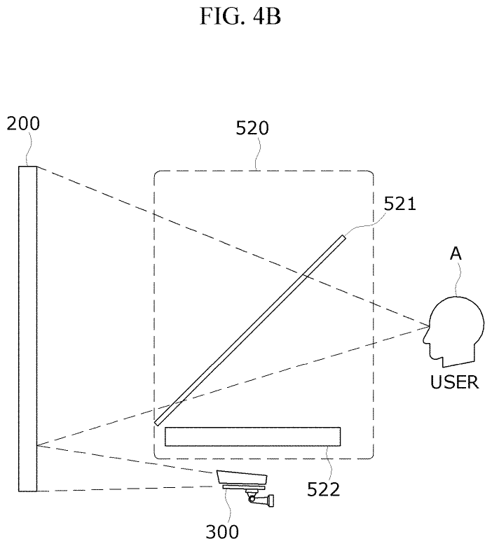

FIGS. 4A and 4B are diagrams illustrating application examples of an AR simulator according to one embodiment of the present invention.

Referring to FIG. 4A, a background display 200 reproduces AR code recognized through an image acquirer 300 (camera) together with a front view seen from a moving apparatus.

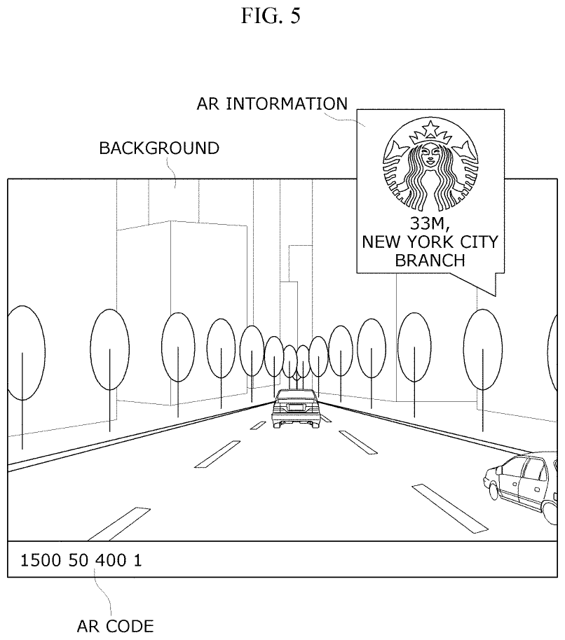

Such a background screen and the AR code are shown in FIG. 5.

The image acquirer 300 recognizes the AR code appearing in a predetermined region of the background display 200 and transmits AR information to an AR content controller 400 (see FIG. 2, not shown in FIG. 4A) as described above.

The AR content controller 400 controls the AR content to be displayed through a transparent display 510 for displaying AR, and user A checks the AR content (AR information), as shown in FIG. 5. For example, the user A may check information (33 meters ahead, Starbucks, New York City branch) about a shop which is currently some distance away from the user.

Referring to FIG. 4B, an AR code recognized by an image acquirer 300 (camera) together with a front view seen from a moving apparatus are represented on a background display 200.

The image acquirer 300 recognizes the AR code, and accordingly, an AR content controller 400 (see FIG. 2, not shown in FIG. 4B) extracts AR content, as described above.

Referring to FIG. 4B, a hologram display 520 for displaying AR is applied, which includes a half-mirror 521 and a general display 522.

The AR content controller 400 controls the AR content to be displayed through the hologram display 520 and user A is allowed to view the AR content.

The recognition of the AR code and the representation of AR content according to the embodiment of the present invention are performed by taking into account at least one of moving information of a viewer, line of sight information, and object information in the background image.

The present disclosure relates to a method of representing content of an AR simulator for a moving apparatus, and the background screen controller 100 allows the image acquirer 300 to more smoothly recognize the AR code by taking into account moving information of the viewer (moving speed and a time period of moving).

For example, when the moving apparatus equipped with the simulator moves in the night time and hence the reliability of AR code recognition is expected to be low due to ambient light from the surroundings, such as a streetlight, the reliability of AR code recognition by the image acquirer 300 may be increased by changing a color of the AR code, a background of a region in which the AR code is displayed, a size of the AR code, and the like.

In addition, in the case in which both the image acquirer 300 and the capture board 600 according to the embodiment of the present invention are applied to a simulator, when it is assumed that an environment is provided where the reliability of AR code recognition by the image acquirer 300 is low, a channel through which a background image signal is transmitted to the capture board 600 is activated and the capture board 600 transmits the corresponding AR code to the AR content controller 400.

The AR content controller 400 according to one embodiment of the present invention may control an output of the AR content by taking into account object information within the background image, and, for example, when it is determined that a color of the object information within a background image located near a region in which the AR information is to be displayed is similar to a color of the displayed AR information, the color of the AR information may be controlled to be changed and then displayed.

The AR content controller 400 according to one embodiment of the present invention may adjust a position, size, and representation method (e.g., applying a flashing effect, such as a cursor) of the AR information to be displayed by taking into account line of sight information of a viewer.

According to the embodiments of the present invention, AR code acquired from a background is recognized according to a change in background in a moving space simulator and AR content is provided according to the recognized AR code so that an efficient synchronization method for implementing AR can be provided.

Advantageous effects of the described technology are not limited to the aforementioned effects, and other advantageous effects that are not described herein should be clearly understood by those skilled in the art from the above detailed description.

While the present invention has been particularly shown and described with reference to the embodiments thereof, it will be understood by those skilled in the art that various changes in form and details may be made therein without departing from the spirit and scope of the invention as defined by the appended claims. The embodiments should be considered in a descriptive sense only and not for purposes of limitation. Therefore, the scope of the invention is defined not by the detailed description of the invention but by the appended claims, and all differences within the scope will be construed as being included in the present invention.

The embodiments of the present invention have been described. It may be understood by those skilled in the art to which the present invention pertains that the present invention can be implemented in modified forms without departing from the essential feature of the present invention. Therefore, the disclosed embodiments should be considered as an illustrative rather than a determinative. The scope of the present invention is defined by the appended claims rather than by the foregoing description, and all differences within the scope of equivalents thereof should be construed as being included in the present invention.

The present invention described above may be embodied as computer-readable code on a program recording medium. The computer-readable medium includes all types of storage devices configured to store data that can be read by a computer system. Examples of the computer-readable medium include a hard disk drive (HDD), a solid-state drive (SSD), a silicon disk drive (SDD), a read-only memory (ROM), a random-access memory (RAM), a compact disc (CD)-ROM, a magnetic tape, a floppy disk, an optical data storage device, and the like. In addition, the computer-readable medium may be implemented in the form of a carrier wave (e.g., transmission through the Internet).

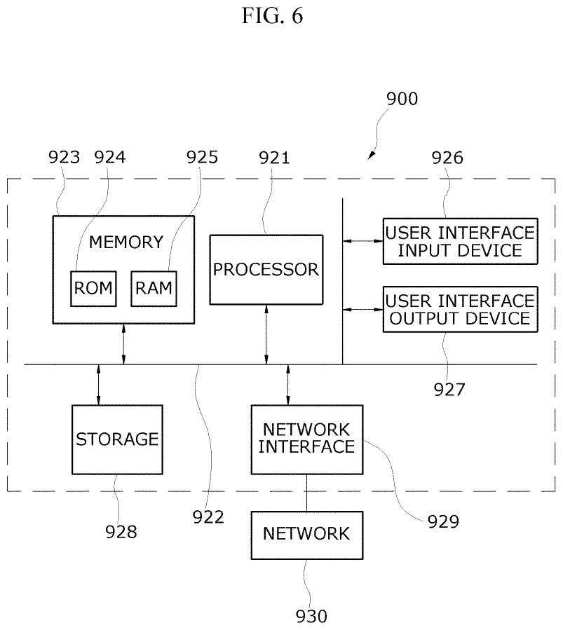

The method according to an embodiment of the present invention may be implemented in a computer system or may be recorded in a recording medium. FIG. 6 illustrates a simple embodiment of a computer system. As illustrated, the computer system may include one or more processors 921, a memory 923, a user input device 926, a data communication bus 922, a user output device 927, a storage 928, and the like. These components perform data communication through the data communication bus 922.

Also, the computer system may further include a network interface 929 coupled to a network. The processor 921 may be a central processing unit (CPU) or a semiconductor device that processes a command stored in the memory 923 and/or the storage 928.

The memory 923 and the storage 928 may include various types of volatile or non-volatile storage mediums. For example, the memory 923 may include a ROM 924 and a RAM 925.

Thus, the method according to an embodiment of the present invention may be implemented as a method that can be executable in the computer system. When the method according to an embodiment of the present invention is performed in the computer system, computer-readable commands may perform the producing method according to the present invention.

The method according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

Further, the above description is to be considered illustrative rather than restrictive in all aspects. The scope of the invention is to be interpreted in a sense defined by the appended claims, and the present invention covers all modifications provided they come within the scope of the appended claims and their equivalents.

What is claimed is:

1. A method of representing content of an augmented reality (AR) simulator, comprising:
recognizing AR code using background image content presented by a background screen controller; and
synchronizing AR content corresponding to the recognized AR code with the background image content and outputting the synchronized AR content.

2. The method of claim 1, wherein the recognizing of the AR code comprises recognizing, through an image acquirer, the AR code presented corresponding to the background image content.

3. The method of claim 2, wherein the recognizing of the AR code comprises recognizing the AR code which includes color code or is presented according to adjustment of transparency.

4. The method of claim 1, wherein the recognizing of the AR code comprises acquiring, through a capture board, image information of the background image content and recognizing the AR code.

5. The method of claim 1, wherein the outputting of the synchronized AR content comprises controlling the AR content to be output through a transparent display for displaying AR or a hologram display for displaying AR.

6. The method of claim 1, wherein the outputting of the synchronized AR content comprises controlling an output of the synchronized AR content by taking into account at least one of movement information of a viewer, line of sight information, and object information within a background image.
